(19) United States
(12) Patent Application Publication
(10) Pub. No.: US 2005/0257473 A1
(43) Pub. Date: Nov. 24, 2005

(54) Anchor and anchoring system

(76) Inventors: Robert Shaw, Parma, MI (US); Rick James Morse, Grass Lake, MI (US); David J. Stucky, Brooklyn, MI (US)

Correspondence Address: DUANE MORRIS, LLP;IP DEPARTMENT, 30 SOUTH 17TH STREET, PHILADELPHIA, PA, 19103-4196, US

(21) Appl. No.: 10/824,457

(22) Filed: Apr. 14, 2004

(51) Int. Cl. E06B 3/54

(52) U.S. Cl. 52/480

(57) ABSTRACT

An anchor for installing a plank in a deck system includes a base portion, a plank-engaging portion and a fastener aperture. The plank-engaging portion has at least one protrusion. The fastener aperture has a longitudinal axis disposed at an oblique angle from vertical and extends through the base portion and plank-engaging portion. According to another aspect, a decking anchor has a generally key-hole shaped cross-section and a planar bottom surface.

### FIELD OF THE INVENTION

The present invention relates generally to decking or fencing systems, and more particularly to an improved anchor fastener and anchoring system for decks or fences.

### BACKGROUND

In both new building constructions and renovation projects, there is an increasing demand in the residential, commercial and public building construction industries to provide private homes, businesses such as shops and restaurants, and public park facilities with deck structures. These structures typically comprise joists overlain with planks or floor boards and bound by a plurality of posts. Because of its natural beauty, comparatively low cost and abundant supply, wood has historically been the predominant material of choice in the construction of decks and similar structures, e.g., walkways, steps, and boat decks and piers. However, the lumber used in the construction of such structures requires considerable and costly maintenance to slow its inevitable deterioration caused by continual exposure to the sun, rain, snow and other natural elements. Moreover, wooden decks and related structures are subject to splintering which can be a hazard to individuals in bare feet. And, wooden structures are highly flammable.

The traditional manner of attaching wooden decking planks to underlying joists is by nailing or screwing through the plank into the joist below. This attachment method presents a number of disadvantages. For example, nail or screw heads exposed on the top surface of the decking planks are aesthetically unappealing and may also present tripping, scratching or splintering hazards. Further, the nails may be pried upwards away from the joists by flexing of the deck planks caused by repeated foot traffic. Additionally, the use of nails or screws necessarily creates holes the decking planks which may cause the wood to split, and which may accelerate deterioration of the plank caused by weather or insects. Further disadvantages include increased difficulty of cleaning and/or painting the decking planks.

Recently, decking systems using rigid plastics such as polyvinyl chloride (PVC), and plastic/fiber composites have become an increasingly popular alternative to wood in the construction of decks and similar structures. These decking systems have been designed with various securing mechanisms. According to some of these designs, the flooring planks are secured to fastener strips which in turn are secured to the joists. In others, the decking planks are secured directly to the joists via screws or similar fastening means.

U.S. patent application Ser. No. 10/365,870 to Bruchu et al. discloses a decking system formed of extruded thermoplastic wood fiber composite having hollow profile deck planks which interact with decking anchors to form a platform structure. The deck planks have anchor flanges which cooperate with the anchor structure. The anchor structure has a shape that conforms to the anchor flanges to hold the planks in place. The anchor structure includes a vertical aperture into which a fastener is inserted to fix the anchor in place. This decking system requires a fairly complex design for the cooperating planks and anchor.

U.S. Pat. No. 5,953,878 to Johnson discloses a decking system formed of extruded hollow polyvinyl or plastic planks having a plurality of slots on the side surfaces which overly the joists. The slots are engaged by mounting cleats which act to secure the planks to the joints and to each other. The cleats include a vertical slot through which a fastener is inserted to secure the cleat to the underlying frame. The cleat in slot arrangement allows for the different rates of thermal expansion and retraction of the plastic planks compared to the supporting wood frame.

U.S. Pat. No. 5,660,016 to Erwin et al. discloses an extruded plastic decking plank and attachment system having planks formed of a rigid foam core and a resilient outer plastic shell. The attachment system includes hold down blocks which have a shape that cooperates with clamping portions on the planks to secure the planks to a support structure. The hold down blocks are secured to the support structure by a fastener which is inserted vertically through a top of the block.

An improved low cost, easily installed decking structure and decking anchor is desired.

### SUMMARY OF THE INVENTION

According to one exemplary embodiment, an anchor for installing a plank in a deck system includes a base portion, a plank-engaging portion and a fastener aperture. The plank-engaging portion has at least one protrusion. The fastener aperture has a longitudinal axis which is inclined from vertical and extends through the base portion and plank-engaging portion.

The anchors described herein may advantageously be used to secure planks to joists in decking systems. Unlike current decking systems having anchors with vertical fastener apertures, which require an installer to keep the anchor tight against the joist when installing the fastener, the angled aperture of the anchors described herein reduces or eliminates the need for a tight controlled positioning of the anchor.

According to another aspect, a decking system includes a plurality of anchors and a plurality of planks. The anchors include a base portion, a plank-engaging portion, and at least one fastener aperture. The plank-engaging portion includes at least one protrusion. The fastener apertures have a longitudinal axis disposed obliquely from a vertical plane and which extend through the base portion and plank-engaging portion. The planks include a side wall having an anchor-engaging groove for cooperating with a corresponding protrusion of a corresponding anchor.

According to a further aspect, a method of installing a deck system comprises providing a plank having an anchor-engaging groove, providing an anchor having a plank-engaging portion and a fastener aperture having a longitudinal axis which is disposed obliquely from a vertical plane, laying the plank on a decking joist, inserting the plank-engaging portion of the anchor into the anchor-engaging groove of the plank, and inserting a fastener through the fastener aperture and into the decking joist.

According to another aspect, a decking system includes a plurality of decking planks, a plurality of anchors and a plurality of fasteners. The decking planks are disposed over supporting joists. Each of the decking planks have a first and second curvilinear side edge portion. The anchors have first and second side surfaces capable of frictionally mating between the first and second curvilinear side edge portion of adjacent ones of the decking planks. The fasteners are disposed through the anchors at an oblique angle from vertical for joining the decking planks to the supporting joists.

According to another aspect, a decking anchor has a generally key-hole shaped cross-section and a planar bottom surface.

According to another aspect, a system for anchoring adjacent planar members to a base member includes a plurality of anchors, a plurality of planar members and at least one base member. The plurality of anchors have a base portion, a planar member-engaging portion having at least one protrusion, and at least one fastener aperture with a longitudinal axis disposed obliquely from a vertical plane and extending through the base portion and planar member-engaging portion. The plurality of planar members include a side wall having an anchor-engaging groove for cooperating with a corresponding protrusion of a corresponding anchor. The anchors are fastened into the base member.

### BRIEF DESCRIPTION OF THE DRAWINGS

FIG. 1 is an end view of a partial decking system according to one exemplary embodiment.

FIG. 2 is a top view of a partial decking system.

FIG. 3A is an isometric view of an exemplary anchor.

FIG. 3B is an isometric view of another exemplary anchor.

FIG. 4 is a top isometric view of a decking plank of the decking system of FIG. 1.

FIG. 5 is a top view of a partial decking system according to another exemplary embodiment.

FIG. 6 is an isometric view of a further exemplary anchor.

FIG. 7 is an isometric view of another exemplary anchor.

FIG. 8 is an isometric view of another exemplary anchor.

FIG. 9 is an isometric view of a partial decking system employing the anchor of FIG. 8.

FIG. 10 is an elevational side view of a partial decking system employing another exemplary anchor.

FIG. 11 is a front view of an exemplary partial fencing system.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

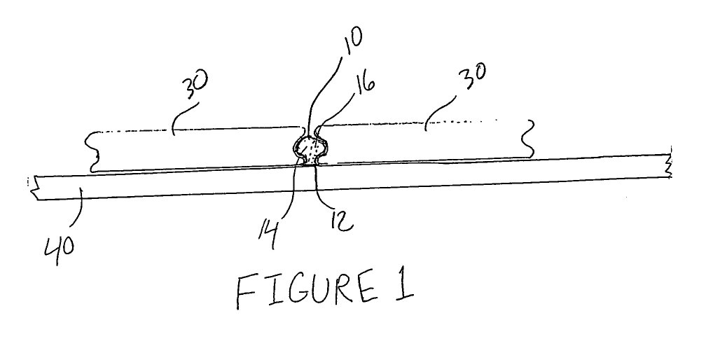

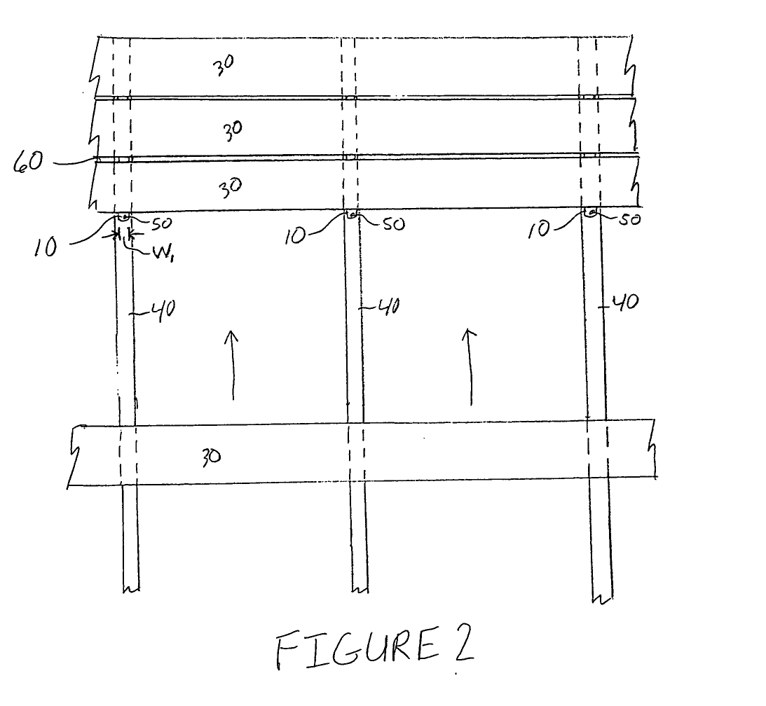

Referring to FIGS. 1 and 2, an exemplary embodiment of a partial decking system 100 is shown including a plurality of anchors 10, a plurality of planks 30, a plurality of joists 40, and a plurality of fasteners 50.

The anchors 10, planks 30 and joists 40 of decking system 100 may be comprised of a variety of materials, including wood, metal, polymer, and composite materials. These articles may be cut, molded, drawn, injection-molded or extruded, for example. Preferably, the planks and anchors are comprised of a thermoplastic/fiber composite. The thermoplastics that can be used may include polyethylene, polypropylene, polyvinyl chloride, polystyrene, polyacrylic materials, polyester materials and other common thermoplastics. More preferably, the anchors, planks and/or joists are comprised of an extruded vinyl/wood composite such as that employed in BOARDWALK® Composite decking and railing systems sold by CertainTeed Corporation of Valley Forge, Pa. The consolidation of vinyl and wood fibers into composite reinforcement may be made in-situ during in-line extrusion of the final end product extrudate, or, alternatively, prepared as a tape or rod and incorporated into an off-line extrusion of final product. The commingled fibers may also be pultruded, followed by overlay extrusion of a capstock polymer using a separate extruder, all in-line. In this case, the capstock polymer would preferably cover only the outside surface of the plank, anchor and/or joist. The capstock may be applied by coating or painting as well as coextruding. The polymer or composite articles, or the capstock overlaying the articles, may further include pigments, thermal stabilizers, impact modifiers, ultra-violet (UV) radiation screening agents and other performance and/or aesthetic enhancing additives.

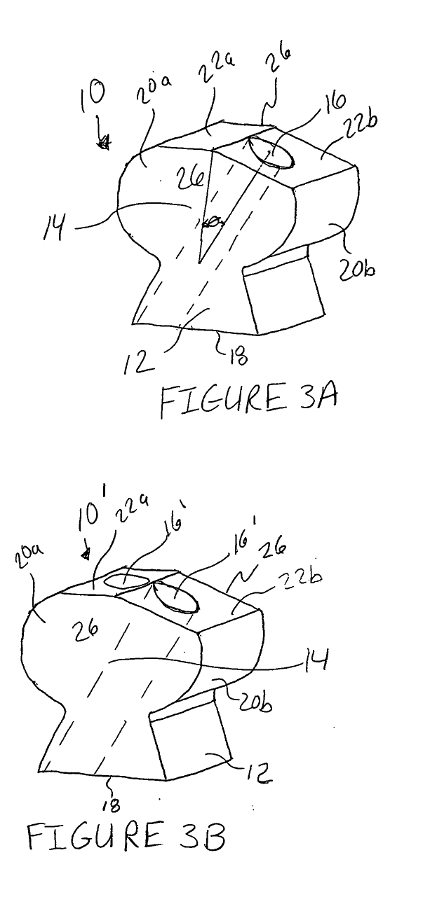

Referring to FIGS. 1-3B, the anchor 10, 10′ comprises a base portion 12, a plank-engaging portion 14, at least one fastener aperture 16, 16′ and side walls 26. A bottom surface 18 of the base portion 12 lies on the joist 40. As best shown in FIGS. 3A and 3B, the sides 24 of the plank-engaging portion 14 are preferably substantially semi-circular in shape, i.e., a cross-section of the plank-engaging portion 14 is circular or oval in shape. Side walls 26 of anchor 10 are substantially flat. The plank-engaging portion 14 includes two protrusions 20a-b, each protrusion capable of engaging a corresponding anchor-engaging groove 38 on an adjacent plank 30. The protrusions 20a-b are preferably shaped to substantially conform to the anchor-engaging grooves 38 of the planks 30. The top of each protrusion 20a-b preferably includes a substantially planar section 22a-b which serves as the entry point for the fastener aperture 16, 16′. The planar section 22a-b allows the head of the fastener 50 to lie flush with the planar section 22a-b.

The anchor 10 can have a fastener aperture predrilled or premolded, or the fastener can form its own aperture when it is drilled or nailed, for example. The anchor 10 could also have one or more starter holes or notches for helping to start the fastener. The fastener aperture 16, 16′ is preferably pre-pierced in the anchor 10, 10′. It extends through the plank-engaging portion 14 and the base portion 12 at an oblique angle ø away from vertical. Preferably the angle ø is between about 5 and 60 degrees away from vertical. By placing the fastener aperture 16, 16′ at an angle away from vertical, the bottom surface 18 of the anchor 10, 10′ does not have to be held tight against the joist when installing the fastener as is typically the case with anchors having vertical fastener apertures.

The anchor may include one fastener aperture 16, as shown in FIG. 3A, which begins at the planar section 22a of protrusion 20a, or alternatively may also include a first and second fastener aperture 16′, as shown in FIG. 3B, which begins at the planar section 22b of protrusion 20b. The fastener apertures 16′ may overlap in the anchor 10′ or may be non-overlapping. The inclusion of a second fastener aperture allows the anchor 10′ to be placed adjacent to the plank in either of two orientations to anchor the plank to the joist, resulting in a less labor-intensive installation.

Referring again to FIGS. 2 and 3A-B, in decking system 100, there is preferably a separate anchor 10, 10′ on each joist 40 to anchor each plank 30. Preferably, the anchor 10, 10′ of decking system 100 has a width W₁ less than the width W₂ of the joist 40.

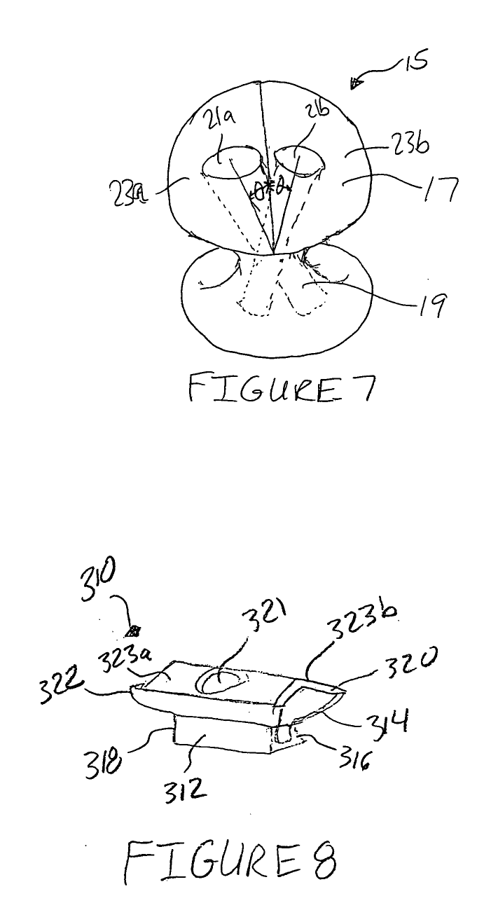

Referring now to FIG. 7, another embodiment of an anchor 15 is shown. Anchor 15 includes a plank-engaging portion 17, a base portion 19 and at least one fastener aperture 21a-b. Unlike anchors 10, 10′ which have side walls 26 that are substantially flat, the entire plank-engaging portion 17 of anchor 15 is substantially spherical, spheroidal or ellipsoidal, and the base portion 19 has a bottom surface which is substantially circular (the anchor 15 resembles a doorknob). Preferably, a top of the plank-engaging portion 17 includes at least one, and preferably two, planar sections 23a-b. The planar sections 23a-b are preferably the entry point for the fastener apertures 21a-b which extend through the plank-engaging portion 17 and base portion 19 at an oblique angle ø away from vertical. Preferably, the angle ø is between about 5 and 60 degrees away from vertical. Anchor 15 may have one fastener aperture, but preferably has two fastener apertures 21a-b, which may be criss-crossed, overlapping or non-overlapping. The substantially spherical, spheroidal or ellipsoidal configuration of anchor 15 and presence of two fastener apertures allows an installer to place the anchor 15 in nearly any orientation against a plank and have a fastener aperture accessible for inserting a fastener.

Advantageously, anchors 10, 10′, 15 are hidden or substantially hidden from view when installed in the decking system 100. The anchors 10, 10′, and 15 also allow installation of the fasteners 50 from the top of the deck as opposed to the bottom, and therefore makes it easier to build decks which are near ground level. Also, unlike some decking systems having hidden fasteners which require special fasteners, standard fasteners, such as nails or deck screws may be used in decking system 100.

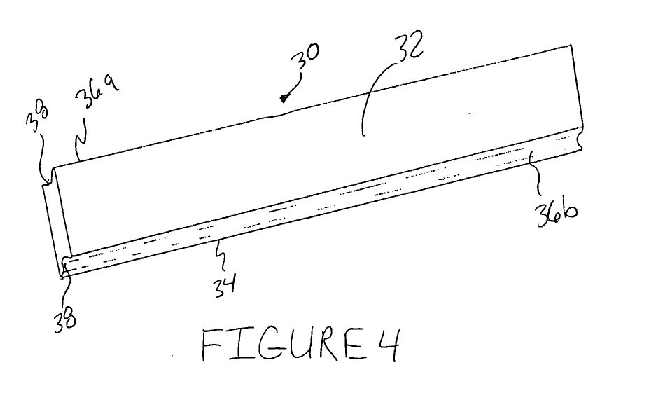

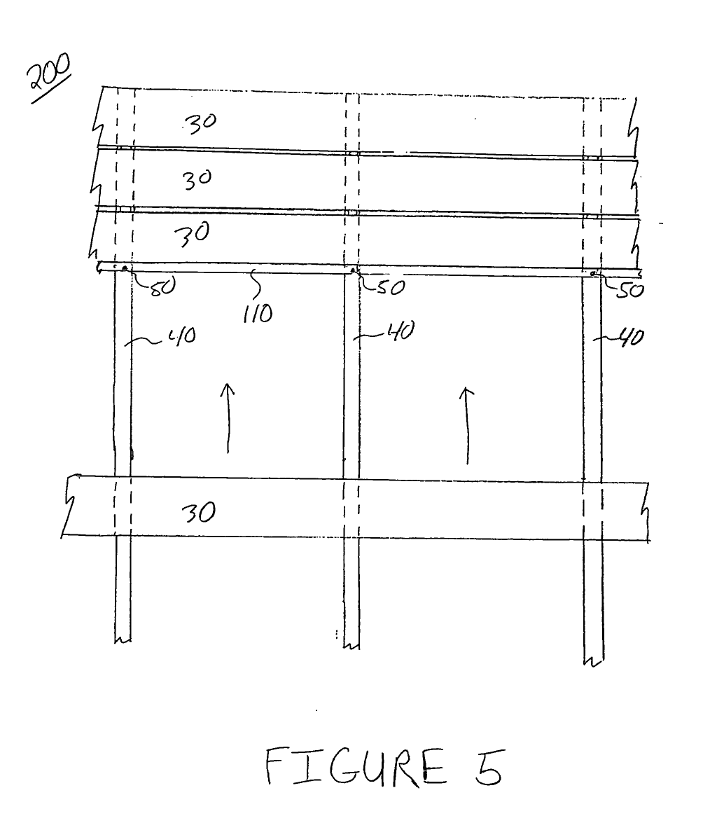

Referring to FIGS. 1 and 4, the planks 30 of decking system 100 include a top surface 32, a bottom surface 34, and two side walls 36a-b. Each sidewall 36a-b includes an anchor-engaging groove 38, which enables the planks 30 to be fastened to the joists 40 by means of the anchors 10, 10′, 15. Preferably the anchor-engaging groove 38 extends the length of the plank 30 as shown in FIG. 4. Alternatively, each side wall 36a-b may include a plurality of anchor-engaging grooves located intermittently along the length of the plank 30 at locations where the plank 30 is to be anchored to the joists 40. Preferably, the anchor-engaging groove 38 has a shape which conforms to the protrusions 20a-b of the anchor 10, 10′, 15. Where the planks are comprised of a metal or a polymer or composite material, the anchor-engaging groove 38 is preferably formed in the plank during manufacture of the plank by molding, drawing or extrusion, depending on the material. Where the planks are comprised of lumber, the anchor-engaging grooves may be formed by a hand tool or a groove-forming machine. The decking system 100 may include one or more end planks (not shown) having only one side wall with an anchor-engaging groove and the other side wall having a flat surface.

The planks 30 can be of any length or width, but preferably have a length and width equal to those of standard wood lumber. Where the planks are comprised of polymer or composite materials, the planks can be fabricated to include a simulated wood grain outer surface. Also, where the planks are comprised of polymer or composite materials, the planks may be substantially solid, partially solid, or hollow. Where the planks are hollow, they may include internal reinforcement braces. As stated above, the planks comprised of a polymer or composite material may include a capstock layer as an outer layer of the plank.

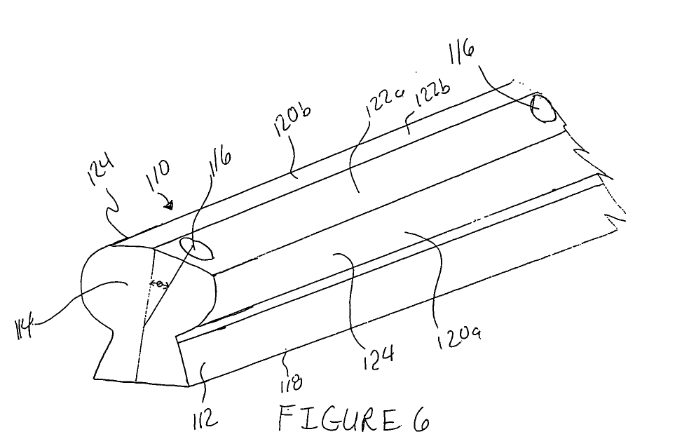

Referring now to FIGS. 5 and 6, an alternative embodiment of a decking system 200 is shown including anchors 110, planks 30 and joists 40. The joists 40 and planks 30 are the same as described above with respect to decking system 100, except that due to the nature of the anchor 110, as described below, the planks of decking system 200 necessarily will contain an anchor-engaging groove which extends the length of the plank 30.

The anchors 110 of decking system 200 comprise a base portion 112, a plank-engaging portion 114, and a plurality of fastener apertures 116. Unlike anchors 10, 10′, 15, anchors 110 preferably extend substantially the length of the planks 30. This configuration of the anchor advantageously provides extra support for the planks which is beneficial in demanding applications. (Alternatively, the anchors may have a length extending at least the distance between two joists.) A bottom surface 118 of the base portion 112 lies on the joist 40. As best shown in FIG. 6, the sides 124 of the plank-engaging portion 114 are preferably substantially semi-circular in shape. The plank-engaging portion 114 includes two protrusions 120a-b, each protrusion engaging a corresponding anchor-engaging groove 38 on an adjacent plank 30. The protrusions 120a-b are preferably shaped to substantially conform to the anchor-engaging grooves 38 of the planks 30. The top of each protrusion 120a-b preferably includes a substantially planar section 122a-b which serves as the entry point for the fastener aperture 116. The planar section 122a-b allows the head of the fastener 50 to lie flush with the planar section 122a-b.

The fastener apertures 116 are preferably pre-pierced in the anchor 110. They are preferably spaced intermittently along the length of the anchor 110 at locations where the anchor will intersect a joist 40. The fastener apertures 116 extend through the plank-engaging portion 114 and the base portion 112 at an angle ø away from vertical. Preferably the angle ø is between about five and sixty degrees away from vertical. As stated above, by placing the fastener aperture 116 at an angle away from vertical, the bottom surface 118 of the anchor 110 does not have to be held tight against the joist when installing the fastener, as is typically the case with anchors having vertical fastener apertures.

The anchor 110 may include a plurality of fastener apertures 116 having an entry point along only one protrusion as shown in FIG. 6, which begins at the planar section 122a of protrusion 120a, or alternatively, the anchors 110 may include a second set of fastener apertures (not shown) which begin at the planar section 122b of protrusion 120b. The fastener apertures may overlap in the anchor 110 or may be non-overlapping.

As with anchors 10, 10′, 15, anchor 110 is capable of being hidden or substantially hidden from view when installed in the decking system 200.

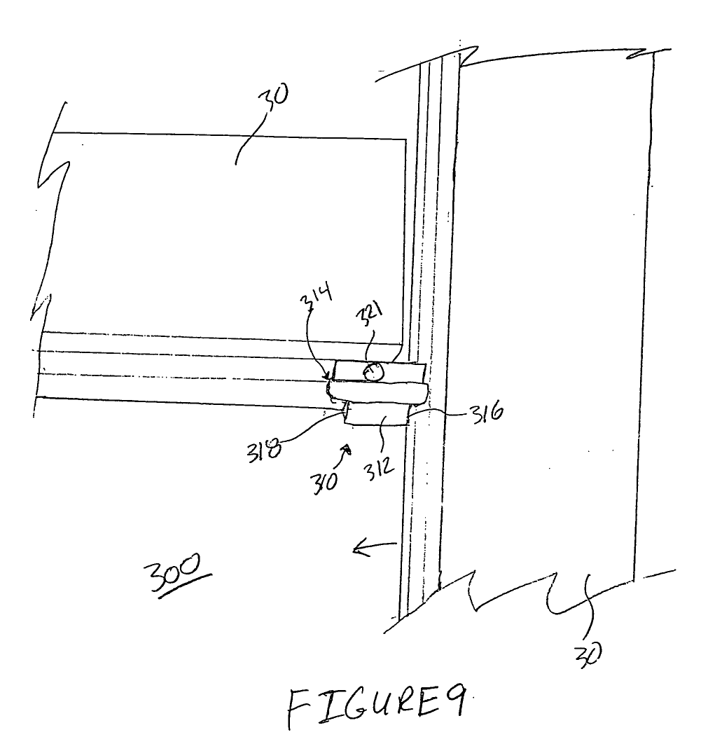

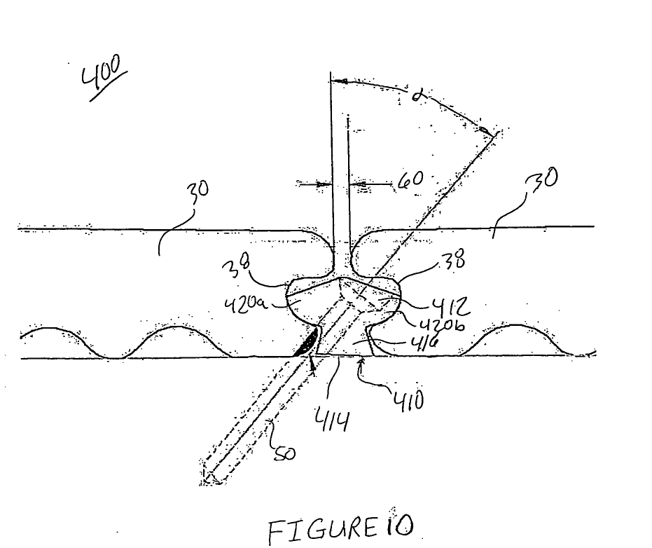

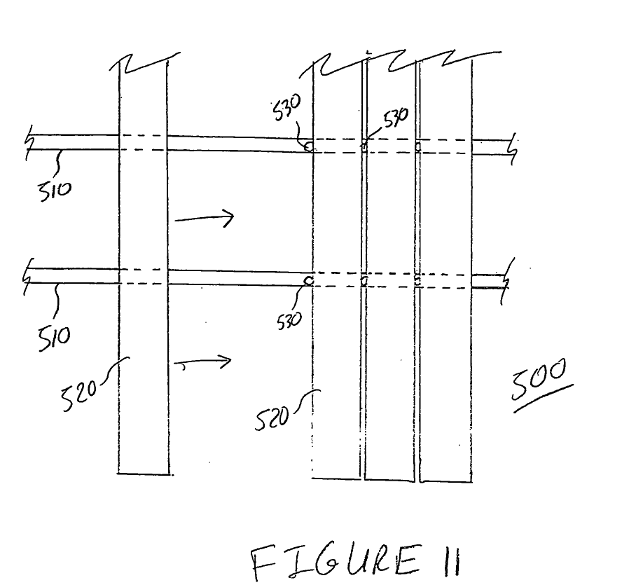

Referring to FIGS. 8-9, another embodiment of an anchor 310 and partial decking system 300 is shown. Anchor 310 includes a plank-engaging portion 314, a base portion 312 and at least one fastener aperture 321. The base portion 312 includes at least one end, and preferably two ends 316, 318, which terminate inwardly from the respective ends 320, 322 of the plank-engaging portion 314 a distance sufficient to allow the respective end of the plank-engaging portion to engage and secure an adjacent plank 30. A top of the plank-engaging portion 314 includes at least one, and preferably two, planar sections 323a-b. The planar sections 323a-b are preferably the entry point for the fastener aperture 321 (or apertures) which extend through the plank-engaging portion 314 and base portion 312 at an oblique angle away from vertical. (The exit point for apertures may be completely enclosed by a bottom surface of the base portion as shown in FIGS. 3A and 3B or may extend at least partially through a side of the base portion as described below and shown in FIG. 10.) Preferably, the angle of the apertures 321 is between about 5 and 60 degrees away from vertical. Anchor 310 may have one fastener aperture 321 (as shown), but preferably has two fastener apertures, which may be criss-crossed, overlapping or non-overlapping.

This anchor embodiment allows the single anchor 310 to be used to secure two planks that are perpendicular to one another, and therefore would be beneficial for employment in picture-framing deck planks (see FIG. 10). The inclusion of two terminated base portion ends 316, 318 of anchor 310 and the presence of two fastener apertures 321 allows an installer to place the anchor 310 in either of two orientations against a plank while having a fastener aperture accessible for inserting a fastener and also an end capable of securing a perpendicular plank. The anchor 15 shown in FIG. 7 may also be used in the decking system 300 to secure perpendicular decking planks.

Referring to FIG. 10, another embodiment of an anchor 410 and decking system 400 is shown. Anchor 410 may have a size and shape similar to any of the anchors described herein, with the difference being that the exit point of the fastener aperture 412 is not entirely through the bottom surface 414 of the base portion 416 of anchor 410, but rather extends at least partially through a side 418 of the base portion 416. The purpose for this angle variation is to allow the fastener 50 to penetrate and directly secure the plank 30 to a joist. This embodiment may prevent the plank from moving due to expansion and contraction of the plank-forming material. Preferably, the fastener aperture 412 is at approximately between a 35-45° angle α away from vertical, and more preferably at approximately a 40° angle away from vertical. However, depending on the shape and width of the protrusions 420a,-b of the anchor 410, and also the distance of any gap between the protrusions and the anchor-engaging groove 38 of the plank 30, the angle from vertical may vary to ensure that the fastener connects with a portion of the plank 30 when inserted through the fastener aperture 412.

Referring to FIGS. 1, 2 and 5, the decking systems 100, 200, 400 are installed by placing planks 30 perpendicularly across a plurality of spaced-apart joists 40. To anchor the planks 30, a bottom surface 18, 118, 414 of the base portion 12, 112, 416 of anchors 10, 10′,15, 110, 410 are placed on joists 40 (in the embodiment shown in FIG. 2, preferably anchors 10 are placed on each joist 40) and a protrusion 20a, 120a, 420a of the anchors 10, 10′, 15, 110, 410 is placed adjacent the anchor-engaging groove 38 of the plank 30 so that the fastener aperture 16, 16′, 116, 412 of the anchor is accessible by an installer. A fastener 50 (or fasteners for anchor 110) is then inserted into the anchor 10, 10′, 15, 110, 410 via the fastener aperture 16, 16′, 116, 412 at an angle away from vertical as dictated by the angle of the fastener aperture. Tightening of the fastener 50 into the joist 40 will pull the anchor snugly into an anchoring position, preferably in firm contact with the anchor engaging groove 38 of the plank 30. Referring to FIGS. 2 and 4, anchoring of one side wall 36b of the plank 30 may also push the plank into firmer engagement with a second set of anchors which have already been installed on an opposite edge 36a of the plank 30 and which have been seated into the anchor engaging groove 38 on the opposite edge 36a. Once the anchors for one side wall 36a of a plank 30 have been fastened to the joist 40, the anchor-engaging groove 38 of another plank 30 is placed against the protrusion 20b, 120b, 420b of the anchor 10, 10′, 15, 110 housing the entry point for the fastener aperture 16, 16′, 116, 412 (or is placed in sufficient enough proximity to the anchor-engaging groove 38 to facilitate anchoring of the plank 30). Depending on the desired appearance and the size and form of the anchor 10, 10′, 15, 110 the anchors may be entirely hidden from view, or a gap 60 of a desired width (preferably from 0-0.5 inch, and more preferably .125 inch) may be left between the planks 30.

Although advantageously employed in decking systems, the anchors and planks described herein may also be beneficially employed in fencing systems to form a fence with a hidden fastening system. Such a system may eliminate unappealing visible nail or screw holes. Referring to FIG. 11, a partial fence 500 is shown including at least one rail 510, a plurality of panels 520 and a plurality of anchors 530. The anchors 530 may be any anchor described herein with respect to a decking system. The anchors are fastened to the rails 510 to secure adjacent panels 520 to the rails 510.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. An anchor for installing a plank in a deck system comprising:
a base portion,
a plank-engaging portion having at least one protrusion, and
at least one fastener aperture having a longitudinal axis which is inclined from vertical and extends through the plank-engaging portion and at least a portion of the base portion.

2. The anchor of claim 1, wherein the anchor has substantially planar side walls, and wherein a cross-section of the plank-engaging portion is substantially circular or oval in shape.

3. The anchor of claim 1, wherein the plank-engaging portion includes two curved protrusions capable of engaging corresponding anchor-engaging grooves on a deck plank.

4. The anchor of claim 1, wherein the plank-engaging portion includes a substantially planar section, and wherein an entrance of the fastener aperture is located on the planar section.

5. The anchor of claim 1, wherein the anchor includes a first and second fastener aperture, and wherein the plank-engaging portion includes two curved protrusions, each curved protrusion having a substantially planar section, and wherein the planar section of each protrusion includes an entrance to a respective fastener aperture.

6. The anchor of claim 5, wherein the first and second fastener apertures are overlapping.

7. The anchor of claim 1, wherein the plank-engaging portion is substantially spherical, spheroidal or ellipsoidal.

8. The anchor of claim 1, wherein the anchor includes a first and second fastener aperture, and wherein the plank-engaging portion includes two curved protrusions, each curved protrusion having a substantially planar section, and wherein the planar section of each protrusion includes an entrance to a respective fastener aperture.

9. The anchor of claim 1, wherein the fastener aperture is at an angle of between five and sixty degrees from vertical.

10. The anchor of claim 1, wherein fastener aperture extends at least partially through a side of the base portion.

11. The anchor of claim 1, wherein an exit point for the fastener aperture is entirely enclosed within a bottom surface of the base portion.

12. The anchor of claim 1, wherein the base portion includes a first and second end, and wherein each end of the base portion terminates short of a respective end of the plank-engaging portion a sufficient distance to allow the plank-engaging portion end to secure a plank.

13. A decking system comprising:
a plurality of anchors, each anchor having a base portion, a plank-engaging portion having at least one protrusion, and at least one fastener aperture with a longitudinal axis disposed obliquely from a vertical plane and extending through the base portion and plank-engaging portion, and
a plurality of planks including a side wall having an anchor-engaging groove for cooperating with a corresponding protrusion of a corresponding anchor.

14. The decking system of claim 13, wherein the anchor-engaging groove of the planks extends substantially the entire length of the planks.

15. The decking system of claim 13, wherein the anchors have a length that is substantially the same length as an adjacent plank.

16. The decking system of claim 13, wherein the anchors have a length extending at least the distance between two adjacent joists.

17. The decking system of claim 13, wherein the anchors include two protrusions, each protrusion having a top portion which serves as an entry point for a plurality of fastener apertures positioned intermittently along the length of the anchors.

18. The decking system of claim 13, wherein the plank-engaging portion of the anchors is substantially spherical, spheroidal or ellipsoidal, and wherein the anchors include a first and second fastener aperture, and wherein the plank-engaging portion includes two substantially planar sections, and wherein each planar section includes an entrance to a respective fastener aperture.

19. A method of installing a deck system comprising:
providing a first plank having an anchor-engaging groove,
providing a first anchor having a plank engaging portion and a fastener aperture having a longitudinal axis which is disposed obliquely from a vertical plane,
laying the first plank on a decking joist,
inserting the plank-engaging portion of the first anchor into the anchor-engaging groove of the first plank, and
inserting a first fastener through the fastener aperture and into the decking joist.

20. The method of claim 19, wherein said inserting a fastener step comprises providing frictional contact between said fastener and said anchor, and between said anchor and said anchor-engaging groove, so as to automatically control the position of said anchor to create a tight joint without further contact with the anchor by an installer.

21. The method of claim 19, further comprising:
providing a second plank having a first and second anchor-engaging groove,
providing a second anchor having a plank-engaging portion and a fastener aperture having a longitudinal axis which is disposed obliquely from a vertical plane,
laying the second plank on the decking joist adjacent the first plank with the first anchor-engaging groove of the second plank engaging the plank-engaging portion of the first anchor, and
inserting the plank-engaging portion of the second anchor into the second anchor-engaging groove of the second plank, and
inserting a second fastener through the fastener aperture of the second anchor and into the decking joist

22. A decking system, comprising:
a plurality of decking planks disposed over supporting joists, each of said decking planks having first and second curvilinear side edge portions;
a plurality of anchors having first and second side surfaces capable of frictionally mating between a first and a second curvilinear side edge portion of adjacent ones of said decking planks;
a plurality of fasteners disposed through said anchors at an oblique angle from vertical for joining said decking planks to said supporting joists.

23. The decking system of claim 22, wherein a pair of adjacent decking planks are locked together by at least one of said anchors.

24. The decking system of claim 23, wherein each of said anchors has at least one aperture therethrough disposed at an oblique angle from a vertical plane.

25. A decking anchor having a generally key-hole shaped cross-section, and a planar bottom surface.

26. The decking anchor of claim 25 having an aperture disposed therethrough from a top surface to said planar bottom surface.

27. The decking anchor of claim 27, wherein said aperture has a longitudinal axis disposed at an oblique angle from vertical.

28. A system for anchoring adjacent planar members to a base member comprising:
a plurality of anchors, each anchor having a base portion, a planar member-engaging portion having at least one protrusion, and at least one fastener aperture with a longitudinal axis disposed obliquely from a vertical plane and extending through the base portion and planar member-engaging portion,
a plurality of planar members including a side wall having an anchor-engaging groove for cooperating with a corresponding protrusion of a corresponding anchor, and
at least one base member into which the anchors are fastened.

29. The system of claim 28, wherein the planar members are planks which form a deck.

30. The system of claim 29, wherein the base member is a joist.

31. The system of claim 28, wherein the planar members are panels which form a fence.

32. The system of claim 31, wherein the base member is a rail.

33. The system of claim 28, wherein the anchors are substantially hidden from view.
